(19) United States
(12) Patent Application Publication
(10) Pub. No.: US 2025/0173967 A1
(43) Pub. Date: May 29, 2025

(54) ARTIFICIAL INTELLIGENCE DEVICE FOR 3D FACE TRACKING VIA ITERATIVE, DENSE AND DIRECT UV TO IMAGE FLOW AND METHOD THEREOF

(71) Applicant: LG ELECTRONICS INC., Seoul (KR)

(72) Inventors: Felix TAUBNER, Toronto (CA); Prashant RAINA, Toronto (CA); Eu Wern TEH, Toronto (CA); Mathieu TULI, Toronto (CA); Jinmiao HUANG, Toronto (CA)

(73) Assignee: LG ELECTRONICS INC., Seoul (KR)

(21) Appl. No.: 18/959,206

(22) Filed: Nov. 25, 2024

Related U.S. Application Data
(60) Provisional application No. 63/602,454, filed on Nov. 24, 2023.

(51) Int. Cl. G06T 17/20; G06T 9/00; G06T 13/40; G06V 10/771

(52) U.S. Cl. CPC G06T 17/20; G06T 9/00; G06T 13/40; G06V 10/771

(57) ABSTRACT

A method for controlling an artificial intelligence (AI) device can include receiving, by a processor, an input two dimensional (2D) image, encoding the 2D image to generate an image feature map, obtaining UV positional encoding information based on a three-dimensional (3D) face model where the UV positional encoding information includes a UV feature map, generating, by the processor, a correlation volume based on the image feature map and the UV feature map, generating flow map information and uncertainty information based on the correlation volume and the UV positional encoding information, and generating probabilistic 2D alignment information based on the flow map information and uncertainty information and outputting the probabilistic 2D alignment information. Also, the method can further include generating 3D reconstruction information based on the probabilistic 2D alignment information for animating a 3D face based on the input 2D image.

### CROSS-REFERENCE TO RELATED APPLICATIONS

This non-provisional application claims priority under 35 U.S.C. § 119(e) to U.S. Provisional Application No. 63/602,454, filed on Nov. 24, 2023, the entirety of which is hereby expressly incorporated by reference into the present application.

### BACKGROUND

### Field

The present disclosure relates to a device and method for receiving a two dimensional (2D) image of a face and generating a three-dimensional (3D) animation of the face, in the field of artificial intelligence (AI). Particularly, the method can use a trained AI model for 3D face tracking through iterative, dense and direct UV to image flow. For example, UV space can be a 2D coordinate system for mapping points on a 3D surface to points on a 2D image.

### Discussion of the Related Art

Artificial intelligence (AI) continues to transform various aspects of society and help users by powering advancements in various fields, particularly with regards to computer graphics, animation and interactive applications.

Also, the field of 3D face animation has seen significant progress that has been driven by the demand for realistic and expressive facial representations in various applications, such as virtual reality, gaming and human-computer interaction.

However, existing methods face several challenges that limit their efficiency, accuracy and robustness. Existing approaches often rely on sparse landmarks and photometric similarity, which is computationally expensive and ineffective in ensuring accurate face motion. For example, these methods may struggle to capture subtle facial deformations and expressions, resulting in animations that lack realism and detail.

Also, existing methods often rely on synthetic or weakly supervised training data, which can hinder their ability to generalize to diverse real-world faces and expressions.

Accordingly, there exists a need for an improved method that can accurately and robustly capture 3D facial animations from 2D videos or images.

Further, a need exists for a method that can receive a two dimensional (2D) image of a face and generate a 3D animation of the face with high quality, realistic and expressive facial animations. Also, a need exists for a trained AI model for 3D face tracking through iterative, dense and direct UV to image flow that can provide reliable and accurate probabilistic 2D alignment information and improved facial animations with better efficiency.

### SUMMARY OF THE DISCLOSURE

The present disclosure has been made in view of the above problems and it is an object of the present disclosure to provide a device and method that can provide speech-driven 3D facial animation, in the field of artificial intelligence (AI). Further, the method can automatically generate 3D facial animations by predicting vertex positions for meshes based on a speech input.

An object of the present disclosure is to provide a method for controlling an artificial intelligence (AI) device that can include utilizing an AI model implementing a two-stage pipeline to generate 3D facial animation from 2D video or images.

An object of the present disclosure is to provide an AI model that can implement a two-stage pipeline including a 2D alignment network that predicts the screen-space positions of each vertex of a 3D morphable model and an 3D model fitting module that jointly fits this model across multiple views by minimizing an alignment energy function.

For example, the AI model can include a 2D alignment network that includes an image feature encoder, a positioning encoding module and an iterative, recurrent optical flow module that predicts a probabilistic UV-image flow. For example, UV space can be a type of 2D coordinate system for mapping points on a 3D surface to points on a 2D image, to help allow for the 2D image to “wrap” onto a 3D object. This network can be trained on high-quality 3D scan data to achieve dense per-vertex alignment. Further, the AI model can include an 3D model fitting module that fits the 3D face model to the predicted vertex locations across multiple frames. According to an embodiment, the overall AI model can be referred to as Flow Face.

Another object of the present disclosure is to provide a method for controlling an artificial intelligence (AI) device that can include receiving, by a processor, an input two dimensional (2D) image, encoding, by the processor, the 2D image to generate an image feature map, obtaining, by the processor, UV positional encoding information based on a 3D face model, the UV positional encoding information including a UV feature map, generating, by the processor, a correlation volume based on the image feature map and the UV feature map, generating, by the processor, flow map information and uncertainty information based on the correlation volume and the UV positional encoding information, and generating, by the processor, probabilistic 2D alignment information based on the flow map information and uncertainty information and outputting the probabilistic 2D alignment information.

It is another object of the present disclosure to provide a method, in which the probabilistic 2D alignment information includes information about points on the 3D face model, a predicted 2D location, and a corresponding uncertainty value.

Yet another object of the present disclosure is to provide a method that includes displaying a 3D facial animation with animated movements based on the 3D reconstruction information.

An object of the present disclosure to provide a method, in which the generating 3D reconstruction information includes optimizing an energy function that includes one or more of an alignment energy component, a prior energy component, a temporal smoothness component, a 3D neural geometry component, and a deformation energy component.

Another object of the present disclosure to provide a method, in which the generating the flow map information and the uncertainty information includes iteratively refining, via a recurrent update block based on a neural network, a UV-to-image flow estimate and an uncertainty estimate based on the recurrent update block receiving, for each iteration, information from the correlation column, a context map, a previous hidden state, a previous flow estimate, and a previous uncertainty estimate to generate a refined flow estimate, a refined uncertainty estimate, and an updated hidden state, and generating the flow map information and the uncertainty information based on the refined flow estimate, the refined uncertainty estimate, and the updated hidden state.

An object of the present disclosure to provide a method, in which the neural network is trained based on a dual loss function that incorporates Gaussian negative loglikelihood (GNLL).

Yet another object of the present disclosure to provide a method, in which the correlation volume is a 4D correlation volume in a form of a tensor.

An object of the present disclosure to provide a method, in which the uncertainty information includes 2D Gaussian information indicating a measure of confidence for a predication of a 2D position of a vertex in the 3D face model.

Another object of the present disclosure to provide a method, in which the UV feature map is a representation of the 3D face model in UV space, the UV space being a 2D coordinate system for mapping points on the 3D face model to points on the input 2D image.

Another object of the present disclosure is to provide an artificial intelligence (AI) device including a memory configured to store facial animation information, and a controller configured to receive an input two dimensional (2D) image, encode the 2D image to generate an image feature map, obtain UV positional encoding information based on a 3D face model, the UV positional encoding information including a UV feature map, generate a correlation volume based on the image feature map and the UV feature map, generate flow map information and uncertainty information based on the correlation volume and the UV positional encoding information, and generate probabilistic 2D alignment information based on the flow map information and uncertainty information and output the probabilistic 2D alignment information.

An object of the present disclosure is to provide an AI device that includes a display configured to display an image, in which the controller is further configured to display, via the display, a 3D facial animation with animated movements based on 3D reconstruction information generated from the probabilistic 2D alignment information.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4, including parts (a) and (b), shows examples of blendshapes and a mesh, according to embodiments of the present disclosure.

FIG. 5 illustrates an example flow chart for a method of generating a 3D animation of the face according to an embodiment of the present disclosure.

FIG. 6 illustrates an example overview architecture of an AI model including a two-stage pipeline, according to an embodiment of the present disclosure.

FIG. 7 illustrates an example architecture of an AI model for generating probabilistic 2D alignment information, according to an embodiment of the present disclosure.

FIG. 8 illustrates an example architecture of an AI model for generating a 3D animation of the face according to an embodiment of the present disclosure.

FIG. 9 illustrates the EPE computation for each frame regarding an SSME evaluation metric, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

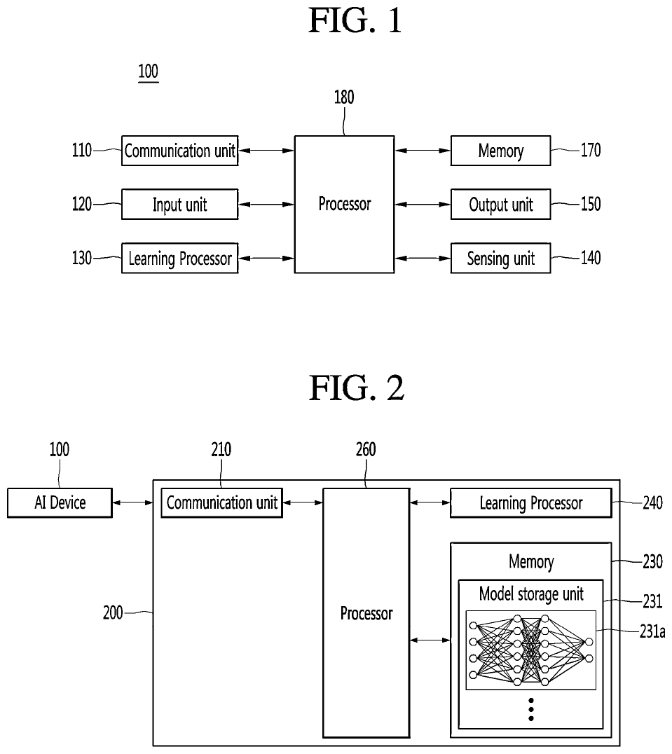

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

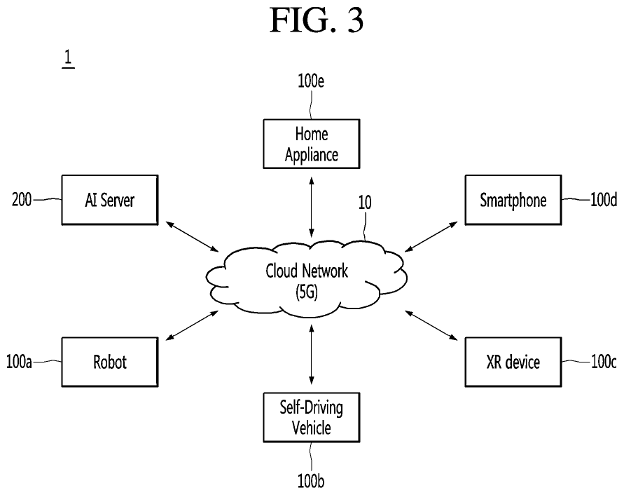

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information. For example, the display unit can display an animated 3D avatar.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement neural network driven animation and can animate facial expressions.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an answer, carry out an action or movement, animate a displayed avatar or a recommend an item or action based on the acquired information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100c and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

At this time, the AI server 200 can learn the artificial neural network according to the machine learning algorithm instead of the AI devices 100a to 100c, and can directly store the learning model or transmit the AI model to the AI devices 100a to 100c.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an animation method, digital avatar assistant, a question and answering system or a recommendation system using an animated avatar, etc. Also, the avatar can perform virtual product demonstrations and provide user tutorials and maintenance tutorials. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face with various expressions and emotions.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar with animated facial movements and expressions.

According to an embodiment, the AI device 100 can provide neural network driven vertex animation, and generate 3D facial animations based on a 2D image.

According to another embodiment, the AI device 100 can be integrated into an infotainment system of the self-driving vehicle 100b in the form of a digital avatar, which can recognize different users and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, generating realistic 3D facial animations is difficult due to several factors, including complexity of facial movements, computationally expensive operations, and scarcity of training data (e.g., which can lead to the infamous “uncanny valley” effect).

Developers typically animate faces and models using either blendshapes (e.g., predefined facial expressions) or by directly manipulating mesh vertices (e.g., individual points that define the 3D model). Blendshapes can be efficient but can lack detail and require artistic skill and labor to create. Also, vertex manipulation can offer fine-grained control but can be time-consuming and computationally expensive.

In more detail, blendshapes are a set of predefined 3D shapes or states that a 3D model can smoothly transition between. These shapes can be used to alter the geometry of a character's face or body. Each blendshape represents a specific deformation or pose of the mesh, such as smiling, frowning, blinking, or any other facial expression or shape change.

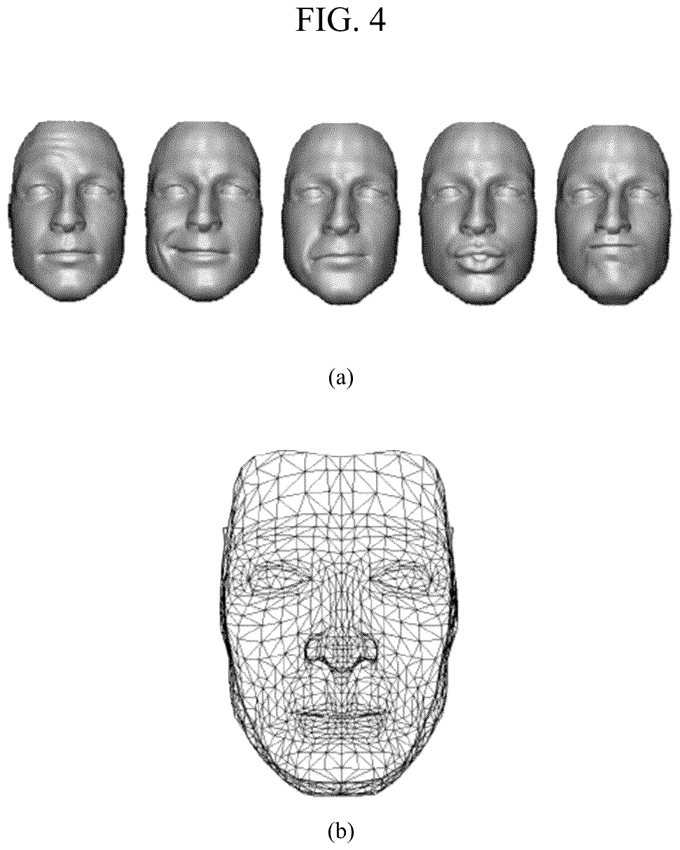

FIG. 4, part (a) shows an example of blendshapes that include a right eyebrow raise, a right lip corner smile, a right lip corn frown, a lip pucker and a chin raise. For example, blendshapes are primarily used for character animation. Instead of deforming the character's mesh using complex skeletal rigging and bone-based animations, blendshapes allow for precise control over the character's facial expressions and other deformations.

For example, a blendshape is a type of morph target used for a 3D model deformation technique where a set of predefined target shapes can be used to alter the geometry of a base mesh. Each blendshape can represent a specific expression or deformation, such as a smile, frown, or raised eyebrow, etc. By blending between these target shapes with varying weights, a wide range of facial expressions and body movements can be created. Blendshapes can be used for characters in video games, digital avatars and animated films.

Animators can create a range of expressions and deformations by blending between different shapes, hence the name “blendshapes.”

Blendshapes are computationally efficient and can be calculated and interpolated in real-time by a game engine, making them suitable for interactive applications like games. This efficiency can help maintain smooth animations at high frame rates and for a large number of vertices.

However, creating blendshapes can be a time-consuming and skill-intensive process, which poses significant challenges when attempting to swiftly generate custom avatars from scanned or photographed user head data. These hurdles can hinder the widespread application of this technology for personalized avatar generation or reconstruction. Also, per vertex control fidelity is limited to the number of blendshapes used.

FIG. 4, part (b) shows an example of a mesh which is a polygonal surface that describes the geometric surfaces of a face or other object. For example, a mesh refers to a 3D model or object that is represented as a collection of vertices, edges, and faces (e.g., polygons) to create a 3D shape or structure.

Meshes can be used to represent and render objects and characters in 3D environments. A mesh defines the geometric structure of a 3D object by specifying the positions of its vertices in 3D space. These vertices are connected to form edges and faces, which define the shape of the object. Vertices are the individual points in 3D space that make up the mesh. Edges connect vertices, and faces are formed by connecting multiple vertices and edges to create flat surfaces (e.g., polygons, triangles or quadrilaterals). The combination of vertices, edges, and faces gives the mesh its shape.

In addition, a mesh can provide individual vertex control that offers a superior level of detail, enabling the portrayal of facial expressions that might prove challenging to achieve through blendshape blending alone. Also, mesh animation can allow developers a greater degree of creative freedom.

However, manually controlling mesh vertices poses greater technical complexity and demands more time from artists, especially when dealing with facial animations requiring intricate vertex-level precision. Additionally, compatibility with real-time rendering engines can be difficult, e.g., setting each vertex position individually for every frame can be slow and tedious in game engines.

According to an embodiment, the AI device and method can improve computer animation. For example, according to an embodiment, the method can include automatically generating realistic 3D facial animations based on a 2D input image.

For example, a method for controlling an artificial intelligence (AI) device can include utilizing an AI model implementing a two-stage pipeline to generate 3D facial animation from 2D video or images. The method can include utilization of a trained AI model for 3D face tracking through iterative, dense and direct UV to image flow.

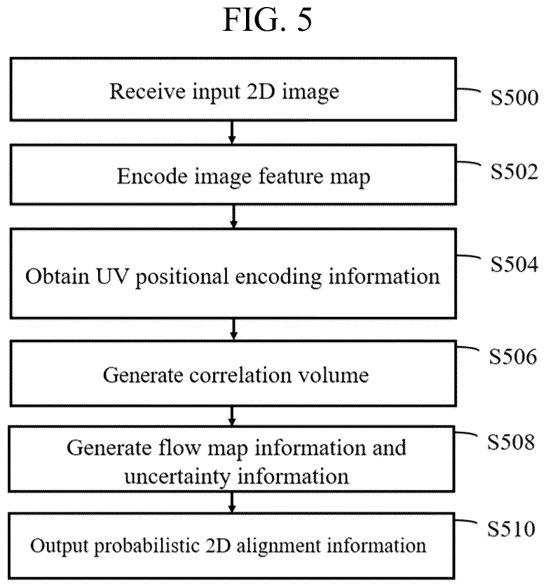

FIG. 5 shows an example flow chart of a method according to an embodiment. For example, according to an embodiment, a method for controlling an artificial intelligence (AI) device can include receiving, by a processor, an input two dimensional (2D) image (e.g., S500), encoding, by the processor, the 2D image to generate an image feature map (e.g., S502), obtaining, by the processor, UV positional encoding information based on a 3D face model, the UV positional encoding information including a UV feature map (e.g., S504), generating, by the processor, a correlation volume based on the image feature map and the UV feature map (e.g., S506), generating, by the processor, flow map information and uncertainty information based on the correlation volume and the UV positional encoding information (e.g., S508), and generating, by the processor, probabilistic 2D alignment information based on the flow map information and uncertainty information and outputting the probabilistic 2D alignment information (e.g., S510).

Also, the method can further include displaying the 3D facial animation with animated movements.

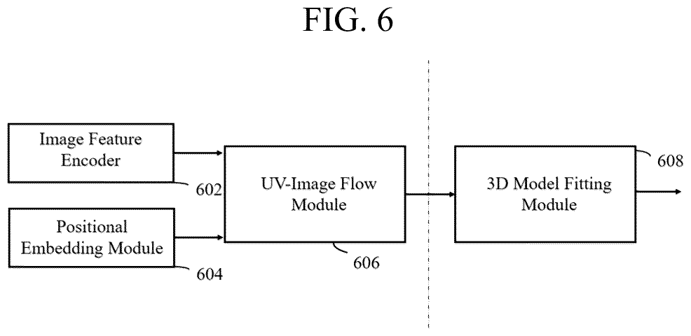

FIG. 6 illustrates an example overview architecture of an AI model including a two-stage pipeline, according to an embodiment. For example, the AI model can include an image feature encoder (e.g., 602), a positional encoding module (e.g., 604), an UV-image flow module (e.g., 606), and a 3D model fitting module (e.g., 608), which are discussed in more detail below.

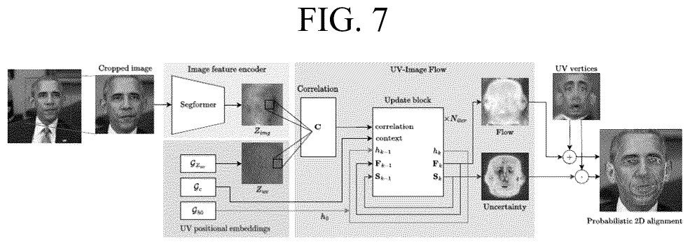

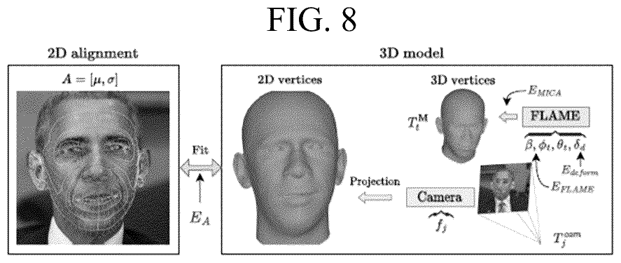

FIG. 7 shows an example overview of a 2D alignment network architecture (e.g., a first stage), according to an embodiment. Also, FIG. 8 shows an example overview of a 3D model fitting architecture (e.g., a second stage), according to an embodiment.

According to an embodiment, an AI model for generating 3D facial animation based on a 2D image can include four main components, such as an image feature encoder, a positional encoding module (e.g., including a set of G modules), and iterative, recurrent optical flow module (e.g., UV-image flow module), and a 3D model fitting module (e.g., optimization). Also, the recurrent optical flow module (e.g., UV-image flow module) can include a correlation block and an update block.

The image space position and uncertainty of each vertex can then be bi-linearly sampled from the intermediate correspondence and uncertainty map for each iteration according to Equation 1, below.

$${μ}_{i , k} = {v}_{i} + {F}_{k} ( {v}_{i} ) and {σ}_{i , k} = {S}_{k} ( {v}_{i} ) \qquad [ Equation 1 ]$$

In Equation 1, vᵢ∈U denotes the pre-defined UV coordinate of each vertex. According to an embodiment, these can be manually defined by a 3D artist. However, according to another embodiment, the pre-defined UV coordinates can be synthetically generated.

For example, the image feature encoder can produce a latent feature map of the target image, the positional encoding module can produce learned positional embeddings in UV space, the UV-image flow module can predict a probabilistic UV-image flow.

According to an embodiment, the image feature encoder module can receive an input 2D image of a face and transform it into meaningful representation that captures essential facial features and their spatial relationships. The process can include obtaining a cropped and resized face image, obtained by first detecting the face in the original image using a face detector and then cropping and resizing it to a standard input size.

Further, the image feature encoder module can include a vision transformer (ViT) specifically designed for dense prediction tasks. According to an embodiment, the vision transformer can be based on Segformer, but embodiments are not limited thereto. For example, other types of vision transformers can be modified for use in the image feature encoder module, such as a swim transformer, CrossVit or a pyramid vision transformer, etc.

For example, the vision transformer (e.g., Segformer) can process the input image through multiple stages, each involving overlapping patch embedding, where the image is divided into overlapping patches that can be converted into vector representations. These patch embeddings can then be input into a transformer encoder, which utilizes self-attention mechanisms to capture relationships between different patches. In this way, the image feature encoder module can learn which parts of the image are relevant to each other, effectively capturing local details within patches and global context across the entire image.

Also, according to an embodiment, each stage of the vision transformer can produce a feature map with a progressively lower resolution or dimensions creating a hierarchy of features, such as fine-grained details in the early stages to more abstract representations in the later stages.

The final output of the image feature encoder module can be a feature map with a reduced resolution that can provide a rich and compact representation of the input face image, encoding important facial features and their spatial relationships. This image feature map can then be used by the UV-image module in the subsequent correlation and iterative refinement steps to establish accurate correspondences between the 2D image and the 3D face model.

In more detail, according to an embodiment, to obtain the input to the image feature encoder module (F), a Single Shot Scale-invariant Face Detector (SFD) can be used to detect a square face bounding box from the target image and enlarge it by 20%. Then, the image can be cropped to the bounding box and resized to D_{img}.

Then, using the vision transformer, which can be based on modifying Segformer to replace the final classification layer with a linear layer to produce a 128-dimensional feature encoding. This 128-dimensional feature encoding can be further down sampled to obtain a final image feature map Z_{img}∈R^{D}^{ᵤᵥ}^{×D}^{ᵤᵥ}^{×128} through average pooling, which can be defined as Equation 2 below, with image I and network parameters θF.

$${Z}_{img} = ℱ ( I , {θ}_{ℱ} ) \qquad [ Equation 2 ]$$

Then, the image feature map Z_{img} can be input to the UV-image flow module.

The UV positional encoding module (e.g., including a set of G modules) can also provide input to the UV-image flow module.

For example, the UV positional encoding module can provide foundation type information about the 3D face model's structure to the UV-image flow module.

According to an embodiment, the UV positional encoding module can use a template 3D face model and generates outputs that help the UV-image flow module understand the spatial relationships between different parts of the face in UV space. This module operates by first creating a multi-scale texture pyramid from the template face model. This pyramid consists of multiple textures at different resolutions, each capturing different levels of detail. These textures are trainable, meaning the network can learn to optimize them for the task of face tracking.

Also, UV space can be considered as a way to unwrap a 3D object onto a flat, 2D surface. For example, each point on the original 3D object can have a corresponding point on this flattened 2D surface, defined by U and V coordinates, which are similar to X and Y coordinates on a regular 2D plane. This mapping can help allow a 2D image to precisely wrap it around or fit on the 3D object by matching points in the image to their corresponding points in UV space (e.g., similar to the Goode homolosine earth map).

In addition, according to an embodiment, the UV positional encoding module can include a set of modules with identical architectures (e.g., G modules). Each G module can take one of the textures from a multi-scale pyramid and processes it with a pixel-wise linear layer, which can transform the texture into a feature map that encodes spatial information in UV space.

Further, the outputs from the G modules can produce three outputs including a UV feature map, a context map, and an initial hidden state. The UV feature map can capture detailed spatial information about the 3D face model in UV space. The context map can provide a more global view of the face structure (e.g., provide context). Also, the initial hidden state can be used as a starting point for the recurrent processing in the subsequent UV-image flow module.

These three outputs from the UV positional encoder can be input to the UV-image flow module for helping to establish correspondences between the 2D image and the 3D face model, enabling accurate and dense face tracking.

In more detail, the set of G modules can be used to generate learned positional embeddings in UV-space. For example, each G module can include a multi-scale texture pyramid and a pixel-wise linear layer. This pyramid can include four trainable textures with 32 channels and squared resolutions of Dᵤᵥ, Dᵤᵥ/2, Dᵤᵥ/4, and Dᵤᵥ/8, respectively.

Further in this example, each texture can be upsampled to Dᵤᵥ through bi-linear interpolation before concatenating them along the channel dimension. The concatenated textures can then be passed through a pixel-wise linear layer to produce the UV positional embeddings. The multi-scale setup can ensure structural consistency in UV space (e.g., closer pixels in UV should have similar features).

In addition, the three modules can include a first module G_{Zuv} to generate a UV feature map Zᵤᵥ, a second module G_{c} to generate a context map c, and a third module Gₕ_{₀} to generate an initial hidden state hₒ. With the corresponding network parameters θ G_{Zuv}, θ G_{c}, and θ Gₕ_{₀}, this can be described according to Equation 3, below.

$${Z}_{uv} = 𝒢 ( {θ}_{{𝒢}_{{Z}_{uv}}} ) ; c = 𝒢 ( {θ}_{{𝒢}_{c}} ) ; {h}_{0} = 𝒢 ( {θ}_{{𝒢}_{{h}_{0}}} ) \qquad [ Equation 3 ]$$

Then, the three outputs from the UV positional encoder can be input to the UV-image flow module for helping to accurately align the 2D image with the 3D face model.

As discussed above, the UV-image flow module can receive the image feature map Z_{img} from image feature encoder module and the three outputs from the UV positional encoder, e.g., the UV feature map Zᵤᵥ, the context map c, and the initial hidden state hₒ.

Regarding the UV-image flow module, the UV-image flow module is configured to perform aligning of the 2D image with the 3D face model.

For example, the UV-image flow module can receive the rich feature representation of the 2D face image from the image feature encoder and combine it with the structural information (e.g., Zᵤᵥ, context map c, and hₒ) about the 3D face model provided by the UV positional encoder.

Further in this example, the UV-image flow module can include a correlation block that compares the image features with the UV features (e.g., via matrix multiplication), which can be viewed as finding how different parts of the face in the 2D image relate to corresponding points on the 3D model's surface. This comparison can result in a 4D correlation volume, which is like a type of lookup table that can map points in the image to points in the 3D face model's UV space.

In addition, in order to refine the mapping provided by the 4D correlation volume, the UV-image flow module can include a recurrent update block that iteratively refines the alignment by incorporating contextual information and considering the uncertainties associated with matching points in the 2D image to the 3D model. In this way, the alignment can be gradually adjusted to allow correspondence between the 2D image and the 3D model to fit together perfectly.

Further, the UV-image module output a probabilistic 2D alignment, which can be viewed as a prediction of where each vertex of the 3D face model should be located in the 2D image. This prediction can be a probability distribution which captures the uncertainty associated with the prediction (e.g., represented as a 2D Gaussian). In this way, this probabilistic representation can help achieve robust and reliable 3D face tracking.

Also, the probabilistic 2D alignment can sent to the 3D model fitting module for the 3D model fitting stage, which can reconstruct the full 3D face animation.

In more detail, according to an embodiment, the UV-image flow module can include an iterative flow estimate module, as such as the RAFT network (Recurrent All-Pairs Field Transforms). However, embodiments are not limited thereto and other types of iterative flow estimate modules can be used (e.g., a CNN based model, FlowNet, etc.).

For example, the RAFT module can predict the optical flow between two images. The RAFT module can include a correlation block that maps the latent features encoded from each image into a 4D correlation volume. A context encoder can initialize the hidden state of a recurrent update block and provides it with additional context information. The update block can then iteratively refine a flow estimate while sampling the correlation volume.

According to an embodiment, the RAFT module can be adapted to predict the UV-image flow F∈R^{D}^{ᵤᵥ}^{×D}^{ᵤᵥ}^{×2}. For example, Zᵤᵥ and Z_{img} can be input the correlation block C. The context map c and initial hidden state hₒ output from the UV positional embedding model can be used for the update U. The update module can be modified to also predict a per-iteration uncertainty in addition to the flow estimate, by duplicating the flow prediction head to predict a 1-channel uncertainty map S∈R^{D}^{ᵤᵥ}^{×D}^{ᵤᵥ}.

Further, according to an embodiment, an exponential operation can be applied to ensure positive values. The motion encoder head can be adjusted to accept the uncertainty as an input.

In addition, the UV-image flow module (e.g., which can be based on modified RAFT) can proceed as follows. For each iteration k, the recurrent update block can perform a look-up in the 4D correlation volume, context map c, previous hidden state hₖ₋₁, previous flow Fₖ₋₁ and previous uncertainty Sₖ₋₁. The recurrent update block can output the refined flow estimate Fₖ and uncertainty Sₖ and the subsequent hidden state hₖ, which can be represented as Equation 4, below.

$${F}_{k} , {S}_{k} , {h}_{k} = U ( C ( {Z}_{uv} , {Z}_{img} ) , c , {F}_{k - 1} , {S}_{k - 1} , {h}_{k - 1} , {θ}_{U} ) \qquad [ Equation 4 ]$$

In Equation 4, θ_{U} is the update weights.

In addition, the UV-image flow module can be trained based on two losses, a first loss for each vertex (e.g., Equation 5) and a second loss for areas where there are no vertices (e.g., Equation 6).

For example, training of the AI model can be supervised with Gaussian negative loglikelihood (GNLL) both on the probabilistic per-vertex positions and the dense UV-image flow. For each iteration k of the update block, a per-vertex loss function can be applied, according to Equation 5, below.

$${L}_{k}^{vertex} = {\sum }_{i = 1}^{{N}_{v}} {λ}_{i} ( log ( {σ}_{i , k}^{2} ) + \frac{{‖ {μ}_{i , k} - {μ}_{i}^{′} ‖}^{2}}{2 {σ}_{i , k}^{2}} ) \qquad [ Equation 5 ]$$

In Equation 5, λᵢ is a pre-defined vertex weight and μ′ is the ground truth vertex position.

Further, the AI model can be encouraged to predict coherent flow and uncertainty maps in areas with no vertices by applying the GNLL loss for each pixel p in UV space, according to Equation 6, below.

$${L}_{k}^{dense} = {\sum }_{p ∈ \vert 𝒰 \vert} {λ}_{p} ( log ( {S}_{k , p}^{2} ) + \frac{{‖ {F}_{k , p} - {F}_{p}^{′} ‖}^{2}}{2 {S}_{k , p}^{2}} ) \qquad [ Equation 6 ]$$

In Equation 6, λₚ is a pre-defined per-pixel weight, and F′ is the ground truth UV-image flow.

Also, according to an embodiment, a final loss can be used for training the AI model that can be a weighted sum of these two losses, which can have a decay factor for each iteration of α=0.8 and a dense weight of λ_{dense}=0.01, according to Equation 7 below. However, embodiments are not limited thereto, and different numbers can be used for iteration of a and the dense weight according to design considerations.

$$Loss = {\sum }_{k = 1}^{{N}_{iter}} {α}^{{N}_{iter} - k} ( {L}_{k}^{vertex} + {λ}_{dense} {L}_{k}^{dense} ) \qquad [ Equation 7 ]$$

For example, according to an embodiment, the AI model can be trained based on a dual loss function. However, embodiments are not limited thereto, and two or more losses could be used for training.

Further, the trained UV-image flow module can output the probabilistic 2D alignment information to the 3D model fitting module which can generate 3D reconstruction information.

The probabilistic 2D alignment information can include a prediction of where each vertex of the 3D face model is located in the 2D image, along with a measure of uncertainty for each prediction. For example, the probabilistic 2D alignment information can include information for a grid of points overlaid on an image of face, in which each point corresponds to a vertex of the 3D face model, and each vertex can be represented by a 2D Gaussian distribution. According to an embodiment, the Gaussian information can include a mean (μ) that is the most likely location of the vertex in the image, and standard deviation (σ) which is a measure of uncertainty in the location. For example, a larger standard deviation can mean that the model is less certain about the exact position of that vertex.

According to an embodiment, probabilistic 2D alignment information can be represented as a list or an array, where each element corresponds to a vertex and can include a Vertex ID: An identifier for the vertex, location information such as (x, y) coordinates of the Gaussian, and standard deviation (σ) such as information representing the standard deviation in the x and y directions, but embodiments are not limited thereto. For example, the probabilistic 2D alignment information can be organized according to various formats, according to embodiments and design considerations.

With reference to FIG. 8, according to an embodiment, the 3D model fitting module can generate a realistic 3D face animation from a 2D video. For example, the 3D model fitting module can receive the probabilistic 2D alignment information (e.g., estimations of where the 3D face model's vertices are located in the 2D image), and use this information to reconstruct the full 3D face, including its shape, pose and expression over time, etc.

Further, the 3D model fitting module can use a parametric 3D face model, such as FLAME (Facial Landmarks and Expression Model), which is capable of representing a wide range of face shapes and expressions.

The fitting process can include finding the optimal set of parameters for the 3D face model (e.g., such as the FLAME model) that best matches the predicted 2D vertex locations from the previous stage.

For example, this can be based on minimizing an energy function that measures the difference between the predicted 2D locations and the projected 3D locations from the FLAME model. Also, the energy function can incorporate terms that encourage smooth and natural face motion. The optimization process can adjust the parameters until the model aligns with the 2D observations while also adhering to constraints of natural facial motion and structure.

Also, this optimization process can result in a time-consistent 3D reconstruction of the face, including a detailed 3D mesh representing the facial geometry, the head pose, the facial expression parameters, and the identity shape parameters. The 3D reconstruction information can capture the nuances of the face's movement and expression over time, providing a rich and realistic representation that can be used for various applications, such as 3D avatar animation, facial expression analysis, video games, face recognition, communication conferencing.

In more detail, according to an embodiment, the 3D model fitting module can generate the 3D reconstruction information based on jointly fitting a 3D head model and camera parameters to the predicted 2D alignment observations (e.g., the 2D probabilistic 2D alignment information from the UV-image flow module) for the entire sequence.

For example, this fitting can be performed based on optimizing an energy function E(Φ; A) with respect to the model parameters Φ and alignment A as shown in FIG. 8.

According to an embodiment, the tracking model can include a 3D head model and a camera model. A tracking sequence can contain C cameras, F frames with a total of C×F images. For the 3D head model, a module such as FLAME can be used as our (e.g., 3D head model M). As an example, the 3D head model can include N_{ν}=5023 vertices, which are controlled by identity shape parameters β∈R³⁰⁰, expression shape parameters φ∈R¹⁰⁰ and K=5 skeletal joint poses θ∈R^{3K+3} (including the root translation) through linear blend skinning. However, embodiments are not limited thereto and other types of 3D head models and variations can be used, according to embodiments and design considerations.

According to an embodiment, the root, neck and jaw pose can be ignored, e.g., the FLAME model includes deformations due to jaw rotation within the expression blendshapes.

Further, additional static per-vertex deformations δ_{d}∈R^{N}^{_{ν}}^{×3} can be used to enhance identify shape detail.

The local head model vertices for the 3D model fitting module can be defined by the various parameters according to Equation 8, below.

$$M ( β , {δ}_{d} , ϕ , θ ) = FLAME ( β , ϕ , θ ) + {δ}_{d} \qquad [ Equation 8 ]$$

In Equation 8, the rigid transform T^{M}∈R^{3×4} represents the head pose which transforms head model vertices i into world space for each frame t, according to Equation 9 below.

$${x}_{i , t}^{3 D} = {T}_{t}^{M} {M}_{i} \qquad [ Equation 9 ]$$

Further, the 3D model fitting module can include a camera model with cameras described by the world-to-camera rigid transform T_{cam}∈R^{3×4} and the pinhole camera projection matrix K∈R^{3×3} defined by a single focal length f∈R parameter. The camera model defines the image-space projection of the 3D vertices in camera j according to Equation 10 below.

$${x}_{i , j , t}^{2 D} = {K}_{j} {T}_{j}^{cam} {x}_{i , t}^{3 D} \qquad [ Equation 10 ]$$

Further, the parameters Ψ include the head model and camera parameters, which are optimized to minimize E(Φ; A). According to an embodiment, the camera parameters can be fixed to known values, if the calibration is available. Expression and poses can vary for each frame t, whereas camera, identity shape, and deformation parameters are shared over the sequence according to Equation 11 below.

$$Ψ = \{ β , {Φ}_{F \times \vert ϕ \vert} , {Θ}_{F \times \vert θ \vert} , {δ}_{d} ; {T}_{F \times 3 \times 4}^{M} ; {T}_{C \times 3 \times 4}^{cam} , {f}_{C} \} \qquad [ Equation 11 ]$$

In addition, the energy function for optimization regarding the 3D model fitting module can be defined according to Equation 12 below.

$$E ( Φ ; A ) = {E}_{A} + {E}_{FLAME} + {E}_{temp} + {E}_{MICA} + {E}_{deform} \qquad [ Equation 12 ]$$

Also, E_{A} encourages 2D alignment according to Equation 13 below.

$${E}_{A} = {\sum }_{i , j , t}^{{N}_{v} , C , F} {λ}_{i} \frac{{‖ {x}_{i , j , t}^{2 D} - {μ}_{i , j , t} ‖}^{2}}{2 {σ}_{i , j , t}^{2}} \qquad [ Equation 13 ]$$

Regarding Equation 13, E_{A} encourages 2D alignment, where for vertex i seen by camera j in frame t. μ_{i,j,t} and σ_{i,j,t} is the 2D location and uncertainty predicted by the final iteration of our 2D alignment network, and x^{2D}i,j,t (e.g., Equation 10) is the 2D camera projection of that vertex.

Further, the 3D model fitting module can improve smoothness of the animation and reduce jitter. For example, Eₜₑₘₚ applies a loss on the acceleration of the 3D position of every vertex x^{3D} of the 3D model to prevent jitter and encourage a smoother, more natural face based on Equation 14 below.

$${E}_{temp} = {λ}_{temp} {\sum }_{i , j , t = 2}^{{N}_{v} , C , F - 1} {‖ {x}_{j , t - 1}^{3 D} - 2 {x}_{j , t}^{3 D} + {x}_{j , t + 1}^{3 D} ‖}^{2} \qquad [ Equation 14 ]$$

In addition, E_{MICA}=λ_{MICA}∥M_{Φ=0,θ=0}−M_{MICA}∥² can provide a 3D neutral geometry prior for the optimizer to enable a better disentanglement between identity and expression components. For example, it can include the L2 distance of the neutral head model vertices of the MICA template.

The MICA template can be computed by predicting the average neutral head vertices using the MICA model for all frames of the sequence. The term also enables a more accurate 3D reconstruction since the model can rely on MICA predictions where the alignment is uncertain, such as in the depth direction or for occluded vertices. In areas of confident alignment, the MICA prediction can be refined. For example, E_{deform}=λ_{deform}∥δd∥² encourages per-vertex deformations to be small with respect to the FLAME model.

According to an embodiment, a method can include generating a screen space motion error (SSME) metric to better evaluate tracking performance of the AI model. For example, the screen space motion error (SSME) can measure how accurately a face tracking method captures facial movements in a video. SSME can evaluate how facial features move over time and compares the predicted movement to the actual movement. For example, the smaller the error, the better the method is at tracking and recreating realistic facial expressions.

In more detail, regarding SSME, face tracking can be reformulated as an optical flow prediction problem over a set of time windows. For example, the ground truth mesh and predicted mesh can be projected into screen space using the respective camera model.

Then, the screen space coordinates can be used to compute the ground truth optical flow f′_{t:t+h} and predicted optical flow f_{t:t+h} from frame t to frame t+h for each frame t∈[1, . . . , F] and a sequence of frame windows h=[1, . . . , NH].

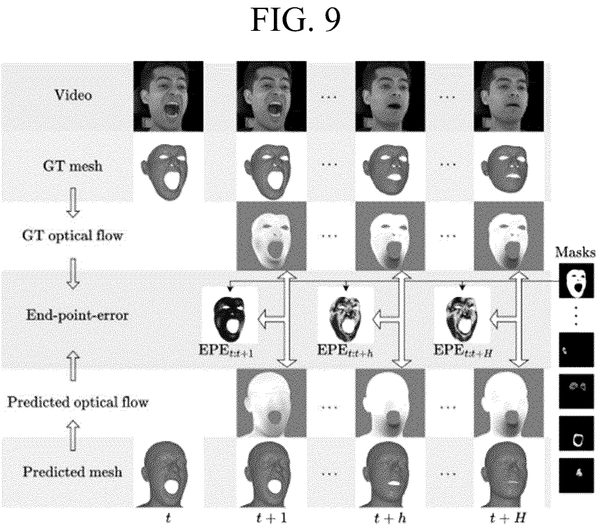

For each frame and frame window, the average end-point-error EPE_{t:t+h} can be computed by averaging the L2-distance between ground truth and predicted optical flow for each pixel, based on Equation 15 below. For example, FIG. 9 illustrates the EPE computation for each frame, according to an embodiment.

$$E P {E}_{t : t + h} = {‖ V ⊙ ( {f}_{t : t + h} - {f}_{t : t + h}^{′} ) ‖}^{2} \qquad [ Equation 15 ]$$

In Equation 15, V is a mask to separate different face regions and ⊙ is the Hadamard product.

Then, the screen space motion error SSMEₕ for frame window h can be defined as the mean of all EPEs over all frames t where frame t+h exists, according to Equation 16.

$$S S M {E}_{h} = \frac{1}{F - h} {\sum }_{t = 1}^{t + h \leq F} E P {E}_{t : t + h} \qquad [ Equation 16 ]$$

Further in this example, to summarize tracking performance in one value, we compute the average screen space motion error over all frame windows as Equation 17 below.

$$\overline{S S M E} = {\sum }_{h = 1}^{{N}_{H}} S S M {E}_{h} \qquad [ Equation 17 ]$$

For example, the average screen space motion error can measure the average trajectory accuracy of each pixel over a time horizon of NH frames. A maximum frame window of NH=30 (1 second) was used since most human expressions are performed within this time frame, but embodiments are not limited thereto.

Also, since the screen space motion can be directly affected by most face-tracking parameters such as intrinsics, pose, and face shape, it also measures their precision in a holistic manner.

In contrast to existing benchmarks that use sparse key-points, SSME covers the motion of all visible face regions and is invariant to mesh topology. Since SSME operates in screen space, SSME does not require additional alignment and works with all camera models, unlike 3D reconstruction or depth errors.

The evaluate the performance of the overall AI model (e.g., FlowFace) according to an embodiment, results were measured using the SSME measurement of the embodiment discussed above and the scan-to-mesh chamfer distance (CD) metric, with and without temporal information sharing, for the AI model of the embodiment and other models including DECA, EMOCA, HRN, 3DDFAv2, PRNet, SADRNet and MPT.

As shown in Table I below, the AI model (e.g., FlowFace) according to the embodiment consistently outperforms other methods on every single category, metric and face region.

TABLE I

| | No temporal information sharing (single image) | | | | | | | | | |
|---|---|---|---|---|---|---|---|---|---|---|
| | CD (mm) ↓ | | | | | S̅S̅M̅E̅ (px) ↓ | | | | |
| Method | face | mouth | nose | eyes | ears | face | mouth | nose | eyes | ears |
| DECA [14] | 1.37 | 1.29 | 1.32 | 1.08 | 2.68 | 5.66 | 6.16 | 3.60 | 4.25 | 8.34 |
| EMOCA [10] | 1.47 | 1.46 | 1.49 | 1.10 | 2.71 | 6.14 | 7.32 | 3.99 | 4.26 | 8.55 |
| HRN [24] | 1.49 | 1.39 | 1.24 | 1.09 | — | 5.75 | 6.04 | 4.20 | 4.84 | — |
| 3DDFAv2 [19] | 1.53 | 1.52 | 1.59 | 1.24 | — | 7.91 | 9.47 | 6.65 | 6.55 | — |
| PRNet [41] | 1.55 | 1.59 | 1.50 | 1.28 | — | 8.45 | 10.66 | 5.98 | 6.03 | — |
| SADRNet [32] | 1.49 | 1.52 | 1.49 | 1.22 | — | 7.11 | 8.21 | 5.15 | 5.53 | — |
| MPT [57] | — | — | — | — | — | — | — | — | — | — |
| FlowFace | 1.20 | 1.3 | 1.05 | 0.97 | 2.34 | 2.58 | 3.14 | 1.33 | 2.07 | 1.72 |
| | With temporal information sharing (sequence) | | | | | | | | | |
| | CD (mm) ↓ | | | | | S̅S̅M̅E̅ (px) ↓ | | | | |
| Method | face | mouth | nose | eyes | ears | face | mouth | nose | eyes | ears |
| DECA [14] | 1.37 | 1.29 | 1.32 | 1.08 | 2.68 | 5.26 | 6.12 | 3.22 | 3.87 | 7.10 |
| EMOCA [10] | 1.47 | 1.46 | 1.49 | 1.10 | 2.71 | 5.63 | 6.95 | 3.56 | 3.87 | 7.28 |
| HRN [24] | 1.49 | 1.39 | 1.24 | 1.09 | — | 4.63 | 5.39 | 3.02 | 3.68 | — |
| 3DDFAv2 [19] | 1.53 | 1.52 | 1.59 | 1.24 | — | 6.71 | 8.43 | 5.43 | 5.44 | — |
| PRNet [41] | 1.55 | 1.59 | 1.50 | 1.28 | — | 7.54 | 9.80 | 5.25 | 5.35 | — |
| SADRNet [32] | 1.49 | 1.52 | 1.49 | 1.22 | — | 6.18 | 7.46 | 4.31 | 4.72 | — |
| MPT [57] | 1.30 | 1.47 | 1.11 | 0.96 | — | 5.74 | 7.34 | 4.64 | 4.01 | — |
| FlowFace | 1.19 | 1.31 | 1.04 | 0.96 | 2.34 | 2.50 | 3.16 | 1.27 | 2.03 | 1.68 |

As mentioned above, the overall AI model (e.g., FlowFace), which is configured with the image feature encoder, the positional encoding module, and the UV-image flow module, and the 3D model fitting module, can include a training phase and an inference phase.

The training phase is described in more detail, below.

Training can begin by processing a cropped 2D image of a face (e.g., 512×512 pixels). The cropped 2D image can be encoded into a compressed tensor using the image feature encoder. For example, a compressed tensor of dimension Z_{IMG}=D_{UV}×D_{UV}×CHANNELS, where CHANNELS=128, and D_{UV}=32, resulting in a 32×32×128 tensor. Simultaneously, the positional encoding module generates three tensors representing UV positional embeddings (e.g., G_{UV}, G_{C}, and G_{H0}). The G_{UV} tensor is combined with the compressed image tensor Z_{IMG} to create a 4D correlation volume, which captures relationships between the image and UV space.

Then the 4D correlation volume, along with the other two positional encoding tensors (e.g., G_{C} and G_{H0}), are fed into the UV-image flow module. The UV-image flow module can output two tensors, e.g., an offset flow map Fr of size D_{UV}×D_{UV}×2 representing X and Y offsets for each UV vertex, and an uncertainty map Sₖ of size D_{UV}×D_{UV} indicating the confidence level for each vertex position (e.g., a single uncertainty value, ranging from 0 (uncertain) to 1 (certain)). The flow map Fₖ is then applied to an initial UV image, effectively shifting the vertices to align with the input face. For example, after adding the offset flow map Fₖ to the original UV image UV_{IMG}, the vertices on the ear of the 3D model might get shifted to fit the ear of face from the cropped image. This offset/shifting applies to each vertex. This process, resulting in a probabilistic 2D alignment, is performed independently for each frame in the video.

In addition, to optimize the system, using the probabilistic 2D alignment UVIMG_OFFSET, the loss is computed. A distinction here is that for each frame of the video, there are ground truth meshes that perfectly fit the videos because the dataset was generated and manually annotated, which allows for video and mesh pairs that are effectively perfectly aligned.

Then the ground truth meshes can be used to also generate the perfect UV images. This ground truth UV image is compared to the probabilistic 2D alignment using the Gaussian negative loglikelihood (GNLL). Note that there are two losses because there is one loss for each vertex and another loss for areas where there are no vertices (e.g., Equation 5 and Equation 6, above).

This process can be iteratively repeated until convergence is reached or a predetermined number of iterations has occurred.

The inference phase is described in more detail, below. The inference phase is similar to training phase, except loss is not computed, and once the probabilistic 2D alignment information is generated it is fed to the 3D model fitting module.

For example, inference can begin by processing a cropped 2D image of a face (e.g., 512×512 pixels), as before. The cropped 2D image can be encoded into a compressed tensor using the image feature encoder. For example, a compressed tensor of dimension Z_{IMG}=D_{UV}×D_{UV}×CHANNELS, where CHANNELS=128, and D_{UV}=32, resulting in a 32×32×128 tensor. Simultaneously, the positional encoding module generates three tensors representing UV positional embeddings (e.g., G_{UV}, G_{C}, and G_{H0}). The G_{UV} tensor is combined with the compressed image tensor Z_{IMG} to create a 4D correlation volume, which captures relationships between the image and UV space.

Then the 4D correlation volume, along with the other two positional encoding tensors (e.g., G_{C} and G_{H0}), are fed into the UV-image flow module. The UV-image flow module can output two tensors, e.g., an offset flow map Fₖ of size D_{UV}×D_{UV}×2 representing X and Y offsets for each UV vertex, and an uncertainty map Sₖ of size D_{UV}×D_{UV} indicating the confidence level for each vertex position (e.g., a single uncertainty value, ranging from 0 (uncertain) to 1 (certain)).

The flow map Fₖ is then applied to an initial UV image, effectively shifting the vertices to align with the input face. For example, after adding the offset flow map Fₖ to the original UV image UV_{IMG}, the vertices on the ear of the 3D model might get shifted to fit the ear of face from the cropped image. This offset/shifting applies to each vertex. This process, resulting in a probabilistic 2D alignment, is performed independently for each frame in the video.

Then, the probabilistic 2D alignment information is transmitted to the 3D model fitting module. The 3D model fitting module effectively solves an optimization problem.

For example, 3D model fitting module refines an initial 3D face mesh to accurately match the 2D facial features tracked in the video. This refinement process centers around minimizing an energy function, which is similar to training a neural network. The energy function incorporates several terms, each designed to guide the optimization process towards a realistic and accurate 3D face reconstruction.

For example, E_{A}, measures the difference between the mesh's current UV positions and those predicted by the probabilistic 2D alignment, taking into account the uncertainty of those predictions.

Another term, E_{FLAME}, encourages the use of smaller identity and expression parameters, leading to face shapes that are statistically more likely.

Also, to ensure smooth motion across frames, Eₜₑₘₚ penalizes rapid changes in vertex acceleration.

E_{MICA} incorporates a neutral face shape prediction from a separate model (e.g., MICA), helping to constrain the deformations and improve accuracy, especially when the 2D alignment is uncertain.

Finally, E_{deform} limits the extent of vertex deformations from the original FLAME model, preventing unrealistic distortions.

By iteratively adjusting the mesh parameters to minimize this multi-faceted energy function, the 3D model fitting module effectively molds the 3D face model to fit the tracked 2D features while maintaining realistic shape and motion. This process continues until the energy function reaches a minimum or stops changing significantly, resulting in a final 3D face reconstruction that accurately reflects the person's facial expressions and movements in the video.

According to an embodiment, the 3D face reconstruction information output by the 3D model fitting module can include various types of information, such as 3D face mesh information (e.g., an array of vertices (3D coordinates) and an array of faces or surfaces), head pose information (e.g., position and orientation information, such as 3 values for translation and 3 values for rotation), facial expression information (e.g., blendshape weights that can be coefficients that control the deformation of the 3D face model), identity shape information (e.g., a vector of parameters that control the shape of the underlying 3D face mode to represent a unique shape of an individual's face). However, embodiments are not limited thereto, and other types of information and data structures can be used for the 3D face reconstruction information.

According to an embodiment, a method of controlling an AI device can include receiving an input 2D image of a face; encoding the 2D image using an image feature encoder to generate an image feature map; generating, using a UV positional encoder, a UV feature map, a context map, and an initial hidden state based on a template 3D face model; generating a 4D correlation volume based on the image feature map and the UV feature map; iteratively refining a UV-to-image flow estimate and an uncertainty estimate using a recurrent update block, in which the recurrent update block receives, for each iteration, the 4D correlation volume, the context map, a previous hidden state, a previous flow estimate, and a previous uncertainty estimate, and outputs a refined flow estimate, a refined uncertainty estimate, and an updated hidden state; predicting, for each vertex of the 3D face model, a probabilistic 2D location in the 2D image based on the refined UV-to-image flow estimate and the refined uncertainty estimate; and outputting the probabilistic 2D alignment information, in which the probabilistic 2D alignment information includes, for each vertex of the 3D face model, a predicted 2D location and an associated uncertainty.

According to an embodiment, the AI device 100 can be configured to generate probabilistic 2D alignment information and 3D facial animation. The AI device 100 can be used in various types of different situations.

According to one or more embodiments of the present disclosure, the AI device 100 can solve one or more technological problems in the existing technology, such as using a trained AI model for 3D face tracking through iterative, dense and direct UV to image flow to generate reliable and accurate probabilistic 2D alignment information and produce improved facial animations with better efficiency. For example, the AI device can address to need of providing a more realistic and expressive facial animation in interactive applications by leveraging neural networks to predict and generate facial movements with high fidelity and accuracy.

Also, according to an embodiment, the AI device 100 configured with the trained AI model can be used in a mobile terminal, a smart TV, a home appliance, a robot, an infotainment system in a vehicle, etc.

For example, the AI device can be applied in a wide range of interactive applications including a digital avatar or computer animation.

In addition, the method can use a neural network to animate a 3D face with facial expressions.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor, an input two-dimensional (2D) image;
encoding, by the processor, the 2D image to generate an image feature map;
obtaining, by the processor, UV positional encoding information based on a three-dimensional (3D) face model, the UV positional encoding information including a UV feature map;
generating, by the processor, a correlation volume based on the image feature map and the UV feature map;
generating, by the processor, flow map information and uncertainty information based on the correlation volume and the UV positional encoding information; and
generating, by the processor, probabilistic 2D alignment information based on the flow map information and uncertainty information and outputting the probabilistic 2D alignment information.

2. The method of claim 1, wherein the probabilistic 2D alignment information includes information about points on the 3D face model, a predicted 2D location, and a corresponding uncertainty value.

3. The method of claim 1, further comprising:
generating 3D reconstruction information based on the probabilistic 2D alignment information for animating a 3D face based on the input 2D image.

4. The method of claim 3, further comprising:
displaying a 3D facial animation with animated movements based on the 3D reconstruction information.

5. The method of claim 3, wherein the generating the 3D reconstruction information includes optimizing an energy function that includes one or more of an alignment energy component, a prior energy component, a temporal smoothness component, a 3D neural geometry component, and a deformation energy component.

6. The method of claim 1, wherein the generating the flow map information and the uncertainty information includes:
iteratively refining, via a recurrent update block based on a neural network, a UV-to-image flow estimate and an uncertainty estimate based on the recurrent update block receiving, for each iteration, information from the correlation column, a context map, a previous hidden state, a previous flow estimate, and a previous uncertainty estimate to generate a refined flow estimate, a refined uncertainty estimate, and an updated hidden state; and
generating the flow map information and the uncertainty information based on the refined flow estimate, the refined uncertainty estimate, and the updated hidden state.

7. The method of claim 6, wherein the neural network is trained based on a dual loss function that incorporates Gaussian negative loglikelihood (GNLL).

8. The method of claim 1, wherein the correlation volume is a 4D correlation volume in a form of a tensor.

9. The method of claim 1, wherein the uncertainty information includes 2D Gaussian information indicating a measure of confidence for a predication of a 2D position of a vertex in the 3D face model.

10. The method of claim 1, wherein the UV feature map is a representation of the 3D face model in UV space, the UV space being a 2D coordinate system for mapping points on the 3D face model to points on the input 2D image.

11. An artificial intelligence (AI) device, comprising:
a memory configured to store facial animation information; and
a controller configured to:
receive an input two dimensional (2D) image,
encode the 2D image to generate an image feature map,
obtain UV positional encoding information based on a 3D face model, the UV positional encoding information including a UV feature map,
generate a correlation volume based on the image feature map and the UV feature map,
generate flow map information and uncertainty information based on the correlation volume and the UV positional encoding information, and
generate probabilistic 2D alignment information based on the flow map information and uncertainty information and output the probabilistic 2D alignment information.

12. The AI device of claim 11, wherein the probabilistic 2D alignment information includes information about points on the 3D face model, a predicted 2D location, and a corresponding uncertainty value.

13. The AI device of claim 11, wherein the controller is further configured to:
generate 3D reconstruction information based on the probabilistic 2D alignment information for animating a 3D face based on the input 2D image.

14. The AI device of claim 13, further comprising:
a display configured to display an image,
wherein the controller is further configured to display, via the display, a 3D facial animation with animated movements based on the 3D reconstruction information.

15. The AI device of claim 13, wherein the 3D reconstruction information is generated based on optimizing an energy function that includes one or more of an alignment energy component, a prior energy component, a temporal smoothness component, a 3D neural geometry component, and a deformation energy component.

16. The AI device of claim 11, wherein the controller is further configured to:
iteratively refine, via a recurrent update block based on a neural network, a UV-to-image flow estimate and an uncertainty estimate based on the recurrent update block receiving, for each iteration, information from the correlation column, a context map, a previous hidden state, a previous flow estimate, and a previous uncertainty estimate to generate a refined flow estimate, a refined uncertainty estimate, and an updated hidden state, and
generate the flow map information and the uncertainty information based on the refined flow estimate, the refined uncertainty estimate, and the updated hidden state.

17. The AI device of claim 16, wherein the neural network is trained based on a dual loss function that incorporates Gaussian negative loglikelihood (GNLL).

18. The AI device of claim 11, wherein the correlation volume is a 4D correlation volume in a form of a tensor.

19. The AI device of claim 11, wherein the uncertainty information includes 2D Gaussian information indicating a measure of confidence for a predication of a 2D position of a vertex in the 3D face model.

20. The AI device of claim 11, wherein the UV feature map is a representation of the 3D face model in UV space, the UV space being a 2D coordinate system for mapping points on the 3D face model to points on the input 2D image.
